(19) United States
(12) Patent Application Publication
(10) Pub. No.: US 2025/0346385 A1
(43) Pub. Date: Nov. 13, 2025

(54) APPARATUS AND METHOD FOR CONTINUOUS VACUUM COOLING

(71) Applicant: MULTIVAC SEPP HAGGENMÜLLER SE & CO. KG, Wolfertschwenden (DE)

(72) Inventors: Robert MAIER, Babenhausen (DE); Dominik PATZ, Kempten (DE)

(73) Assignee: MULTIVAC SEPP HAGGENMÜLLER SE & CO. KG, Wolfertschwenden (DE)

(21) Appl. No.: 19/200,057

(22) Filed: May 6, 2025

(30) Foreign Application Priority Data
May 7, 2024 (DE) 102024112741.4

(51) Int. Cl. B65B 63/08; B65B 5/04

(52) U.S. Cl. CPC B65B 63/08; B65B 5/045

(57) ABSTRACT

The disclosure relates to an apparatus comprising at least one vacuum cooling station comprising a plurality of vacuum cooling chambers, each of which, while being moved along a cooling path together with at least one product received therein, is controllable for vacuum cooling the at least one product received therein. Each vacuum cooling chamber has its own control circuit device configured for dynamic vacuum pressure generation. The disclosure further relates to a method for vacuum cooling products.

### CROSS-REFERENCE TO RELATED APPLICATIONS

This application claims foreign priority benefits under 35 U.S.C. § 119 (a)-(d) to German patent application number DE 102024112741.4, filed May 7, 2024, which is incorporated by reference in its entirety.

### TECHNICAL FIELD

The present disclosure relates to an apparatus with at least one cooling station. Furthermore, the disclosure relates to a method for vacuum cooling.

### BACKGROUND

DE29607689U1 discloses a thermoforming packaging machine with a sealing station which is followed in the transport direction by a mechanical cooling device which presses on sealed packaging from above and from below by means of cooling pads mounted thereon, in order to cool it downstream of the sealing station after the sealing process.

JPS57-1021A discloses a thermoforming packaging machine with a forming station positioned at the inlet in the production direction for producing thermoforming cavities, a sealing station for producing packaging and a vacuum station positioned between the forming station and the sealing station in order to remove moisture from products enclosed therein.

US2004/0105927A1 discloses a thermoforming packaging machine with a pasteurization station which is positioned upstream of a sealing station of the packaging machine in the production direction. Within the pasteurization station, products arriving therein can be heat-treated by means of a steam supply. Optionally, a vacuum cooling process takes place following the pasteurization process.

EP4335759A2 discloses a thermoforming packaging machine with a plurality of vacuum cooling stations which are positioned along a filling path of the thermoforming packaging machine in order to cool products arriving therein one after the other and combined in a work cycle in accordance with a machine work cycle step by step by means of a generated vacuum, so that they are cooled to a desired temperature level by the time they reach a sealing station positioned downstream.

During vacuum cooling along several vacuum cooling stations, which are integrated into an intermittent operation of a thermoforming packaging machine, these are opened and closed several times for the feed travel according to a machine cycle, the duration of which is, for example, 4 to 8 seconds, in order to carry out the vacuum cooling process in several stages. If longer cooling times are required for vacuum cooling, such as 60 to 90 seconds for cooling hot baked goods, several vacuum cooling stations must be used along the cooling path so that vacuum cooling can take place according to a shorter machine cycle, for example one with a duration of 4 to 8 seconds. The fact that several vacuum cooling stations may be necessary for the intermittent operation of a thermoforming packaging machine makes the design of the thermoforming packaging machine complex and energy-intensive, which increases the manufacturing costs. However, in order to open the vacuum cooling stations for an intermittent feed movement of the respective work cycles, they must also be ventilated after evacuation. This means that vacuum pressure must be built up and then released again and again in the respective vacuum cooling stations. This repeated interruption of the vacuum cooling process, which takes place on intermittently operating thermoforming packaging machines, is time-consuming and energy-intensive and can lead to the products pressurized by evacuation and/or ventilation being unnecessarily stressed and possibly even damaged.

WO2017053682A1 discloses a rotary machine with vacuum chambers for vacuuming products held in packaging and for sealing the vacuumed packages while they are moved along a circular path. The rotary machine has a valve device by means of which various vacuum processes run intermittently depending on a position of the vacuum chambers.

### SUMMARY

A problem underlying the present disclosure is to provide an apparatus and a method for the economical, in particular gentle, vacuum cooling of products.

This problem is solved by an apparatus according to the disclosure. Furthermore, the problem is solved by a method according to the disclosure.

Advantageous embodiments according to the disclosure are provided below.

The disclosure relates to an apparatus comprising at least one vacuum cooling station comprising a plurality of vacuum cooling chambers, each of which, while being moved along a cooling path together with at least one product received therein, is controllable for vacuum cooling the product received therein. According to the disclosure, each vacuum cooling chamber comprises its own control circuit device configured for dynamic vacuum pressure generation. This allows the transportation of the products and the vacuum cooling of the products during transportation to take place continuously along the entire cooling path.

The vacuum cooling chambers moving along the cooling path can be controlled independently of each other, in particular independently of position, to carry out the respective vacuum cooling processes. The respective vacuum cooling processes can be controlled without interruptions, i.e., continuously during the entire movement of the vacuum cooling chambers, so that the products contained therein can be vacuum-cooled along the cooling path in a continuous process, independent of the position of the respective vacuum cooling chambers. A single closing and opening of the respective vacuum cooling chamber is sufficient for the vacuum cooling process of a product or a product format consisting of several products. This results in energy-efficient operation of the apparatus and a cooling process that is gentle on the products. Likewise, due to the elimination of intermittent vacuum cooling steps, the apparatus enables an increased output of vacuum-cooled products.

By integrating the control circuit devices according to the disclosure in the respective vacuum cooling chambers, it is possible to carry out the controlled, continuous vacuum generation within the vacuum cooling chambers independently of the position at which the respective vacuum cooling chambers are located along the cooling path. The movement sequence can therefore be functionally decoupled from the vacuum control at the respective vacuum cooling chambers. This favors both a continuous transport and a continuous cooling process of the products.

The vacuum cooling chambers may each form autonomous modules for vacuum control. The components used for this purpose are structurally integrated in the respective modules. This integral design as such leads to more complex vacuum cooling chambers. However, because the vacuum cooling chambers are moved along the cooling path during vacuum control, the transport and vacuum cooling of the products can take place continuously. This leads to an increased output of vacuum-friendly cooled products.

Preferably, the control circuit devices are each designed to wirelessly receive a vacuum target pressure gradient as a reference variable for dynamic vacuum pressure generation. This wireless signal transmission can simplify the design of the cooling station, in particular the design of a drive unit for the vacuum cooling chambers. In particular, the control circuit devices can each be designed for wireless reception of a ventilation target pressure gradient as a reference variable for dynamic ventilation pressure generation.

The wireless reception of the vacuum or ventilation target pressure gradient used as a reference variable can be carried out by means of a WLAN configured for data transmission, to which the control circuit devices of the respective vacuum cooling chambers are functionally connected. This particularly favors a simplified design of the means used to transport the products.

According to one variant, all control circuit devices are configured for wireless reception of all data signals required for controlling the respective vacuum cooling processes, so that only the power supply to the respective control circuit devices is wired. Each vacuum cooling chamber thus forms a functioning system for controlling the respective vacuum cooling process.

An advantageous embodiment of the disclosure provides that the apparatus for the respective control circuit devices comprises a common control device for providing the respective vacuum target pressure gradient. This control device may, for example, be present as a central control device for several machines which cooperate with the apparatus according to the disclosure. Alternatively, each vacuum cooling chamber may comprise its own control device for providing the respective vacuum and ventilation target pressure gradients.

It would be expedient if the control circuit devices each comprise at least one controllable valve unit. Preferably, the respective valve unit for dynamic evacuation and/or dynamic ventilation comprises at least one adjustable throttle, a proportional valve and/or a servo valve. This allows the flow cross-section to be varied in order to be able to individually control the evacuation and/or ventilation with regard to their respective reference variable at the respective vacuum cooling chambers. Preferably, the valve unit comprises separate, controllable valves for evacuation and ventilation, in particular separate proportional valves and/or servo valves.

Preferably, the valve unit comprises at least one valve that can be switched in parallel with the throttle, the proportional valve and/or the servo valve for an unregulated, maximum evacuation and/or ventilation capacity. This can be opened to accelerate the pressure reduction during evacuation and/or to accelerate the pressure build-up during ventilation, in particular in addition to the throttle, the proportional valve and/or the servo valve.

Preferably, the respective control circuit devices have at least one vacuum pump. The respective vacuum pumps are configured to generate a vacuum within the vacuum cooling chambers that are fluid-connected to them. It would be conceivable for the control circuit devices to be connected to a central vacuum pump shared by them. The central vacuum pump can be connected to the respective valve units in such a way that the valve units in the associated vacuum cooling chambers can be used to control a pressure reduction and/or pressure increase independently of each other.

Preferably, the control circuit devices each comprise at least one pressure sensor for detecting a vacuum-pressure gradient as a controlled variable. In particular, the respective pressure sensors are configured to continuously detect an actual pressure present within the respective vacuum cooling chambers during evacuation.

One variant provides that the respective control circuit devices are designed to determine a manipulated variable for the respective valve unit during evacuation of the respective vacuum cooling chamber, taking into account a target/actual comparison of an actual pressure gradient determined on the basis of actual pressure values detected by means of the pressure sensor with the respective vacuum target pressure gradient received, by means of which the respective valve unit can be controlled from an initial pressure until a final vacuum pressure is reached within the respective vacuum cooling chamber. The target/actual comparison of the vacuum target pressure gradient (reference variable) with the actual pressure gradient (controlled variable) determined on the basis of the feedback, measured actual pressure values may lead to a control deviation at the respective vacuum cooling chamber, on the basis of which a controller of the respective control circuit devices dynamically adjusts the manipulated variable for the evacuation process in order to dynamically influence the evacuation process via the valve unit using the manipulated variable in such a way that a desired evacuation pressure curve can be specifically produced within the respective vacuum cooling chamber. Based on the respective control principle, the evacuation process can be specifically influenced depending on the product to be cooled and the predetermined vacuum target pressure gradient or the desired vacuum pressure curve in order to carry it out effectively and gently for the specific product. In particular, the present control principle makes it possible to actively control the amount of water vapor removed from the product during evacuation by dynamically adjusting the control variable, taking into account a falling product temperature during evacuation.

Preferably, the respective control circuit devices are designed to determine a manipulated variable for the valve unit during ventilation of the respective vacuum cooling chamber, taking into account a target/actual comparison of an actual pressure gradient determined on the basis of actual pressure values detected by means of the pressure sensor with the respective ventilation target pressure gradient received, by means of which the valve unit can be controlled from the final vacuum pressure reached at least temporarily until an adjustable ventilation pressure is reached, which preferably corresponds to the output pressure of the evacuation process. In this variant, the target/actual value comparison of the ventilation target pressure gradient (reference variable) carried out during ventilation with the actual pressure gradient (controlled variable) determined on the basis of the measured actual pressure values fed back may lead to a control deviation, on the basis of which a controller of the respective control loop device dynamically adjusts the control variable for the ventilation process in order to dynamically influence the ventilation process via the valve unit using the control variable in such a way that a desired ventilation pressure curve can be produced in a targeted manner. This allows the aeration process to be influenced in a targeted manner depending on the product to be cooled and the predetermined ventilation target pressure gradient or the desired aeration pressure curve in order to carry it out effectively and gently for the specific product. In particular, this variant makes it possible to actively control the forces generated by the ventilation pressure and applied to the product during ventilation by dynamically adjusting the valve setting in such a way that the products are not damaged.

It would be useful if the respective control circuit devices comprised at least one temperature detection unit, for example a thermal imaging camera or an infrared thermometer. This could be integrated in the respective vacuum cooling chambers in order to detect a product temperature before, during and/or after evacuation and/or ventilation. Based on this, possibly on the basis of an averaged product temperature of several products received in the respective vacuum cooling chambers, a dynamic adjustment of the respective reference variables on the control circuit devices could take place, in particular a dynamic adjustment of the vacuum target pressure gradient or the desired vacuum pressure curve.

An advantageous variant provides for the valve unit to be controllable at least temporarily during evacuation to keep a vapor mass flow or vapor volume flow constant, in particular taking into account a vacuum target pressure gradient that tends to become smaller and is maintained by the control circuit device. In this way, the valve unit counteracts the increasing water vapor extraction associated with decreasing pressure. This favors particularly gentle evacuation. An expedient variant provides for the valve unit to be controllable at least temporarily during ventilation to keep the forces generated by the pressure increase constant, in particular taking into account a ventilation target pressure gradient that tends to increase and is maintained by the control circuit device. This prevents the cooled products from being damaged during aeration.

According to one variant, the apparatus comprises a central power supply for the respective control circuit devices. For example, a central power supply via a rotary feed-through would be conceivable. The rotary guide can be part of a carousel transport device that is configured to move the vacuum cooling chambers along a cooling path formed in a circle.

It would be expedient if the vacuum cooling station comprises at least one drive device for linear and/or non-linear movement of the vacuum cooling chambers along the cooling path. The type of drive device can depend on the machines with which the apparatus works or how the space conditions are created at the place of use.

According to one embodiment, the drive device comprises opposing drive units for moving the respective chamber halves of the vacuum cooling chambers. These drive units can each comprise a return unit to return the respective chamber halves from an exit to an entrance of the vacuum cooling station. At the entrance, chamber halves that belong together can be brought together by means of the drive units in such a way that they form a closed vacuum cooling chamber.

According to one variant, sections of a product conveyor, for example a conveyor belt, are clamped along the cooling path between opposing, joined chamber halves to form several vacuum cooling chambers that move synchronously with the product conveyor along the cooling path.

One variant provides for the respective vacuum cooling chambers to be lockable along the cooling path. This improves process reliability.

According to one embodiment, the drive device comprises several hood-shaped covers to form the vacuum cooling chambers. The respective control circuit devices can be structurally integrated on these covers.

It would be conceivable for the vacuum cooling chambers to have a chamber wall in the closed state, which is formed by a product conveyor. It is possible that this product conveyor, for example in the form of a conveyor belt, together with a hood-shaped lid placed on it, forms a hermetically sealed vacuum cooling chamber. At the exit of the vacuum cooling station, the lid can be removed from the product conveyor and return to the entrance of the vacuum cooling station via a return unit in order to form a vacuum cooling chamber again with the product conveyor along the cooling path.

One variant provides that the apparatus comprises a conveyor for continuously feeding products into the vacuum cooling station. This can be a conveyor belt, which is assigned to the vacuum cooling station. This can be moved continuously and synchronously with the vacuum cooling chambers.

In particular, a packaging line with a baking line, an apparatus according to the disclosure and a tubular bag machine would be conceivable. In this variant, the apparatus configured as a cooling line according to the disclosure follows the baking line in the direction of production in order to continuously pick up products from the baking line, cool them during continuous further transport and transfer them cooled to the tubular bag machine, along which the cooled products can be packaged. A U-shaped packaging line would be conceivable here, in which the baking line and the tubular bag machine are aligned in opposite directions to each other and the apparatus formed as a cooling line in the form of a rotary machine is arranged in the product flow between the baking line and the tubular bag machine. This enables a compact structure in order to be able to carry out a continuous overall process.

The disclosure also relates to a method for vacuum cooling products held in continuously moving vacuum cooling chambers. According to the disclosure, it is provided that each vacuum cooling chamber, while being moved along a cooling path together with at least one product received therein, is operated by means of a separate control circuit device designed for dynamic vacuum pressure generation. This means that the transportation of the products and the vacuum cooling of the products during transportation can take place continuously along the entire cooling path.

Preferably, the control circuit devices each receive a vacuum target pressure gradient wirelessly as a reference variable for dynamic vacuum pressure generation. This wireless signal transmission can simplify the design of the cooling station, in particular a drive device for the vacuum cooling chambers.

According to one embodiment of the disclosure, the vacuum target pressure gradients are formed as a function of a temperature of the products to be cooled. It would be expedient for the respective control circuit devices to detect a product temperature in the respective vacuum cooling chambers before, during and/or after evacuation and/or ventilation by means of at least one temperature detection unit formed thereon, for example by means of a thermal imaging camera or by means of an infrared thermometer. Based on this, possibly on the basis of an averaged product temperature of several products recorded in the respective vacuum cooling chambers, a dynamic adjustment of the respective reference variables on the control circuit devices could be carried out, in particular a dynamic adjustment of the vacuum target pressure gradient or the desired vacuum pressure curve.

The products, in particular baked goods, preferably comprise a core temperature of less than 35° C. after vacuum cooling, in particular 18° C. to 25° C. Preferably, the product or baked goods comprise a core temperature of at least 70° C., preferably at least 78° C., more preferably at least 85° C. at the start of vacuum cooling in the vacuum cooling chamber.

In particular, the products can be cooled by at least 5° C., preferably at least 10° C., preferably at least 15° C., preferably at least 20° C., preferably at least 25° C., preferably at least 30° C., preferably at least 35° C. during vacuum cooling.

### BRIEF DESCRIPTION OF THE DRAWINGS

Embodiments of the disclosure are explained in more detail with reference to the following figures:

FIG. 1 shows a packaging line with a baking apparatus, an apparatus for vacuum cooling baked products and a tubular bag machine for packaging cooled products in schematic representation;

FIG. 2 is a schematic representation of an apparatus for continuous vacuum cooling of products;

FIG. 3 is a schematic representation of another apparatus for continuous vacuum cooling of products;

FIG. 4 is a schematic representation of another apparatus for continuous vacuum cooling of products; and

FIG. 5 is a schematic representation of a continuous vacuum cooling process according to the disclosure and a step-by-step vacuum cooling process not according to the disclosure.

Technical features are marked with the same reference signs throughout the figures.

### DETAILED DESCRIPTION

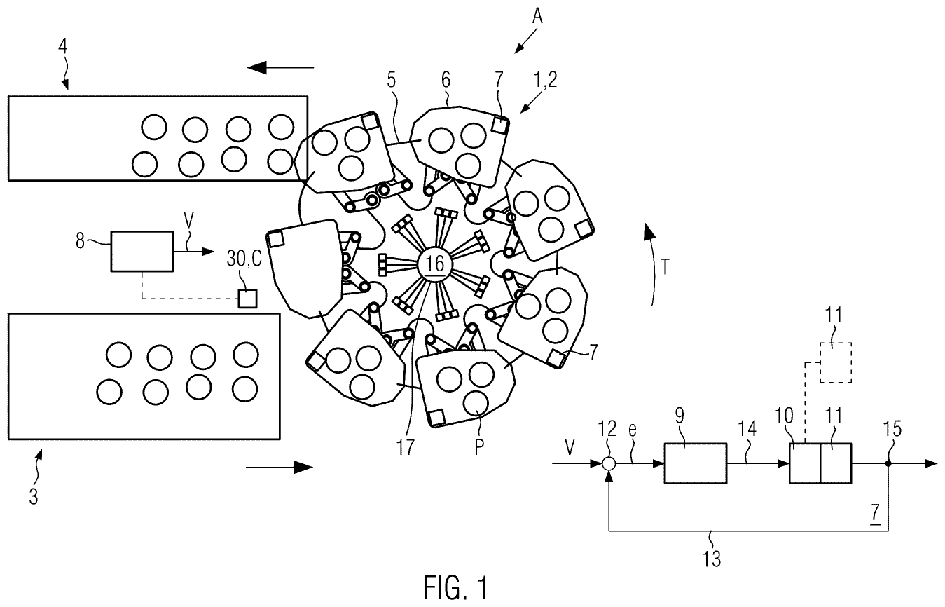

FIG. 1 shows a packaging system A. The packaging system A has an apparatus 1 which is configured for continuous vacuum cooling of products P transported along it. According to FIG. 1, the apparatus 1 is configured as a rotary machine 2. Upstream of the apparatus 1 configured as a rotary machine 2, a baking device 3 is arranged to continuously feed hot baked goods or products P to the apparatus 1. These products P are continuously vacuum-cooled during their transport along the apparatus 1 in order to be transferred at a desired temperature level to a tubular bag machine 4 positioned downstream. The tubular bag machine 4 is designed to package the vacuum-cooled products.

The apparatus 1 for vacuum cooling the products P forms a vacuum cooling station 5 with several vacuum cooling chambers 6 between the baking device 3 and the tubular bag machine 4. The apparatus 1 configured as a vacuum cooling station 5 could alternatively be placed between other devices or machines for the removal of hot products P and the delivery of vacuum-cooled products P in order to continuously cool the products P during their transport by means of a vacuum. It would be conceivable, for example, for the apparatus 1 configured as a vacuum cooling station 5 to continuously transfer vacuum-cooled products to a buffer station, for example at least to a conveyor belt, from which the vacuum-cooled products P are fed to an intermittently operating packaging machine, for example a thermoforming packaging machine, in accordance with a main machine work cycle. In such a packaging system, gentle, in particular time-reduced, continuous vacuum cooling of hot products can be combined with an intermittent packaging process.

FIG. 1 shows that the respective vacuum cooling chambers 6 comprise separate control circuit devices 7, i.e., each comprises a control circuit device 7 configured independently for dynamic vacuum pressure generation. One of these control circuit devices 7 is shown in a schematically enlarged representation in FIG. 1.

The respective control circuit devices 7 are designed to wirelessly receive a vacuum target pressure gradient V as a reference variable for dynamic vacuum pressure generation. According to FIG. 1, the apparatus 1, in particular the packaging system A, has a control system 8. The purpose of the control system 8 is to control and monitor the processes taking place on the apparatus 1, in particular overall along the packaging system A, in particular the vacuum cooling carried out continuously during the transport of the products P along the apparatus 1. In particular, the control system or unit 8 forms a transmitter, preferably a transceiver, for wirelessly sending the vacuum target pressure gradients as reference variables to the respective vacuum cooling chambers 6. For this purpose, the respective vacuum cooling chambers 6 can be provided with individual addresses in order to be able to reliably receive data signals from the control unit 8 wirelessly, for example via WLAN, in the existing network.

The control circuit device 7 in FIG. 1 has a controller 9, a valve unit 10 and a vacuum pump 11. As an alternative to the integrated design of the vacuum pump 11 on the rotary machine 2 shown, the vacuum pump 11 could be positioned as a central vacuum pump 11, for example on a rotary table of the rotary machine 2 or completely isolated from it (shown in FIG. 1 as a dashed, schematic representation of the vacuum pump 11). As the central vacuum pump 11 is used by all vacuum cooling chambers 6, it is connected to the respective valve units 10 of the vacuum cooling chambers 6.

According to FIG. 1, the controllable actuators are all integrated into the structure of the vacuum cooling chamber 6, in particular they are located on a cover formed on it. However, the vacuum pump 11 could also be positioned isolated from the respective vacuum cooling chambers 6 in order to be used jointly by the respective vacuum cooling chambers 6 as a central vacuum pump 11. The valve unit 10 and/or the vacuum pump 11 can be dynamically controlled, taking into account a target/actual comparison 12 between an actual vacuum pressure gradient 13 or actual pressure detected in the control loop during evacuation and the maintained vacuum target pressure gradient V, by means of the control deviation e formed from this and a manipulated variable 14 that can be produced from this, in order to continuously and dynamically control the evacuation process during the transport of the products P in the respective vacuum cooling chamber 6. At least one pressure sensor 15 can be used on the control circuit device 7 to detect the actual vacuum pressure gradient 13.

The respective control circuit devices 7 of the vacuum cooling chambers 6 of the apparatus 1 shown in FIG. 1 may comprise a central power supply 16. In FIG. 1, the central power supply 16 is provided via a rotary feedthrough 17. The design of the apparatus 1 in FIG. 1 thus ensures that only power is supplied to the vacuum cooling chambers 6 by cable from outside. All data signals required for control are sent wirelessly or received from the vacuum cooling chambers 6. Furthermore, the respective control circuit components used for continuous evacuation are all provided on the respective vacuum cooling chambers 6 in order to be able to evacuate them independently of each other.

The vacuum cooling chambers 6 shown schematically in FIG. 1 can comprise plate-shaped product conveyors for transporting the products P, which can be brought together to form hermetically sealed vacuum cooling chambers 6 by means of hood-shaped lid parts that can be placed on them.

A temperature detection device 30 for detecting a product temperature C is assigned to the baking device 3 of FIG. 1 at the exit. The temperature detection device 30 is functionally connected to the control unit 8. On the basis of the measured temperature values, for example an averaged product temperature C of several products P which are to be fed together to a vacuum cooling chamber 6, the control system can send a vacuum target pressure gradient V adapted to this to the control circuit device 7 of this vacuum cooling chamber 6 in order to carry out the vacuum cooling process individually therein depending on the detected, (averaged) product temperature C. For this function, i.e., for the temperature-dependent determination of specific vacuum target pressure gradients V, it would be conceivable to equip the respective vacuum cooling chamber 6 itself with a corresponding temperature detection unit in order to measure the temperature of products P arriving therein and forward it to the control unit 8. The function described here in connection with temperature measurement can also be used in the embodiments shown in the following figures.

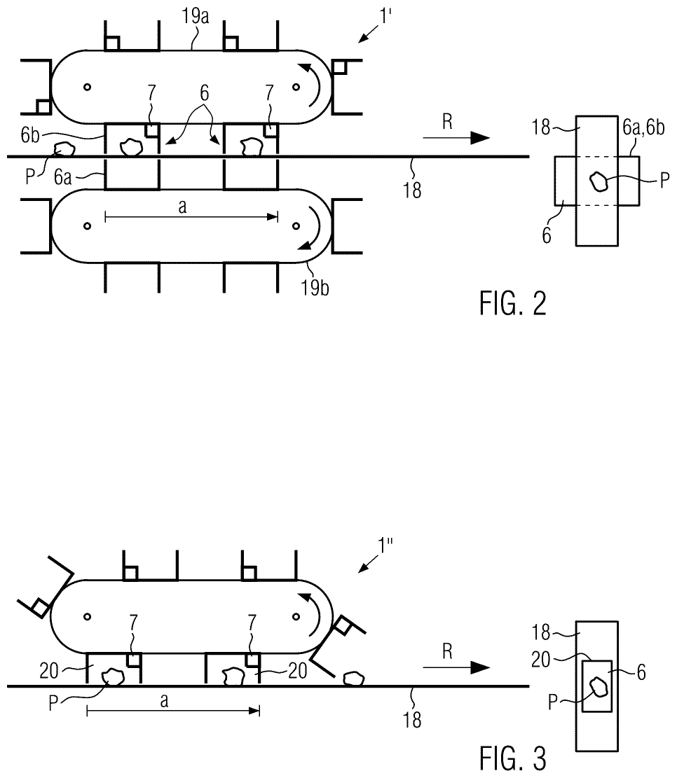

FIG. 2 shows an apparatus 1′ in isolated, schematic representation, which is configured for continuous vacuum cooling of products P which are transported on a product conveyor 18, in particular on a conveyor belt, in the transport direction R. During the transport of the products P in the transport direction R, they are continuously vacuum cooled by means of the apparatus 1′ associated with the product conveyor 18. For this purpose, vacuum cooling chambers 6 are formed one behind the other along the apparatus 1′ in order to continuously vacuum cool the products P during their transport in the transport direction R.

The vacuum cooling chambers 6 of FIG. 2 are each formed from joined lower and upper chamber halves 6a, 6b, which are moved along a transport section “a” synchronously with the product conveyor 18 in the transport direction R and thereby continuously vacuum-cool the products P enclosed in them during their transport.

Opposite drive devices or units 19a, 19b in FIG. 2 are used to move the chamber halves 6a, 6b. Autonomous control circuit devices 7 are provided on each of the vacuum cooling chambers 6 in FIG. 2 in order to be able to control the vacuum cooling processes taking place therein independently of one another.

FIG. 2 also shows a schematic top view of how the product P transported on the product conveyor 18 can be enclosed by the chamber halves 6a, 6b during the continuous cooling process. The chamber halves 6a, 6b project laterally beyond the width of the product conveyor 18 in order to form the vacuum cooling chambers 6 between them.

FIG. 3 shows an alternative apparatus 1″ for continuous vacuum cooling of products P while they are transported along the transport direction R on the product conveyor 18. In this variant, the respective vacuum cooling chambers 6 are formed by the product conveyor 18 and hood-shaped covers 20 placed thereon in order to regulate the respective vacuum processes therein. From the schematic top view shown in FIG. 3, it can be seen that the hood-shaped lids 20 in horizontal projection are seated completely within a width of the product conveyor 18, for example on a conveyor belt, in order to define the vacuum cooling chambers 6 together with it. The apparatus 1″ of FIG. 3 thus forms a vacuum cooling device with reduced installation space for continuous vacuum cooling of the transported products P compared to the apparatus 1′ of FIG. 2.

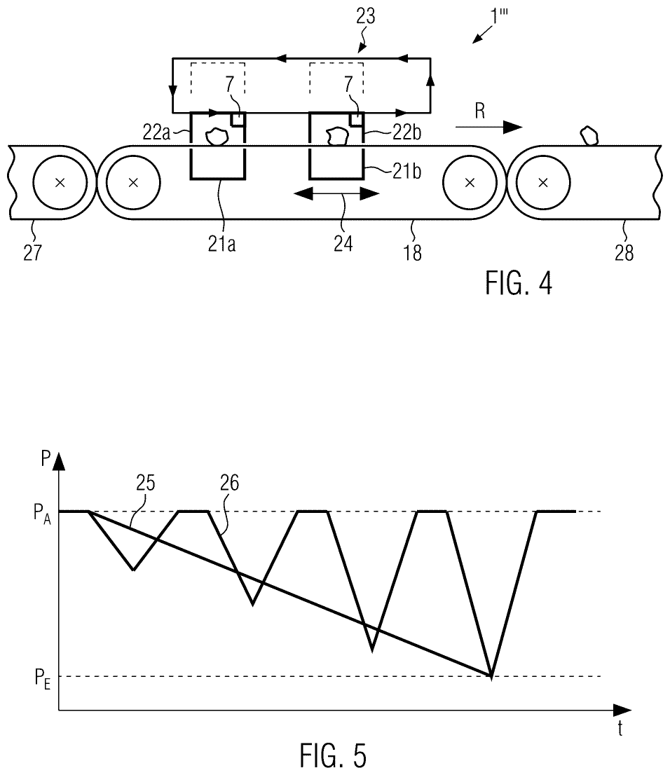

FIG. 4 shows a further apparatus 1′″ which is configured for continuous vacuum cooling of products P fed to it. The apparatus 1″ of FIG. 4 has lower chamber halves 21a, 21b which are mounted so as to be adjustable in and against the transport direction R. These can be combined with chamber halves positioned above them. These can be brought together with chamber halves 22a, 22b positioned above them in such a way that they each form vacuum cooling chambers 6 in order to be able to vacuum cool products P held therein continuously during their transport in the transport direction R, and possibly even against the transport direction R.

The upper chamber halves 22a, 22b can be moved back at the exit of the apparatus 1″ via a common return unit 23 in order to re-enclose hot products P supplied to the apparatus 1″. In the apparatus 1″ shown in FIG. 4, in particular the two lower chamber halves 21a, 21b together with their linear drive device 24, which is configured to move the two chamber halves 21a, 21b in and against the transport direction R, can be integrated within the structure of the product conveyor 18.

The products P can be continuously transferred to the product conveyor 18 by a conveying device 27 shown in FIG. 4, in particular a feed belt. The cooled products P can be continuously received by a discharge belt 28 shown in FIG. 4. A picker device, not shown, can be assigned to this belt in order to pick up the cooled products P from the discharge belt 28 and transfer them to a packaging machine, for example a downstream, intermittently operating thermoforming packaging machine.

FIG. 5 shows a pressure curve 25 according to which continuous vacuum cooling takes place, for example vacuum cooling of products P from an initial pressure PA to a final vacuum pressure PE carried out continuously by means of the apparatus 1, 1′, 1″, 1″. Furthermore, FIG. 5 shows a schematic representation of a pressure curve 26 not in accordance with the disclosure for a vacuum cooling process carried out in stages. Such a vacuum cooling process occurs in particular along an intermittently operating packaging machine, at vacuum cooling stations which are integrated therein and are mounted stationary one behind the other and which are closed and opened intermittently in accordance with a main machine operating cycle of the packaging machine, in order to carry out the respective vacuum cooling processes step by step, i.e., with interruptions, one after the other.

As one of ordinary skill in the art would understand, each of the control circuit devices 7, the control system 8, each of the controllers 9, as well as any other control, controller, unit, system, subsystem, sensor, device, or the like described herein may comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

What is claimed is:

1. An apparatus comprising a vacuum cooling station having a plurality of vacuum cooling chambers each of which, while being moved along a cooling path together with at least one product received therein, is controllable for vacuum cooling of the at least one product received therein, wherein each vacuum cooling chamber comprises its own control circuit device configured for dynamic vacuum pressure generation.

2. The apparatus according to claim 1, wherein the control circuit devices are each designed for wireless reception of a vacuum setpoint pressure gradient as a command variable for dynamic vacuum pressure generation.

3. The apparatus according to claim 1, wherein the apparatus comprises a common control system for the control circuit devices for providing a respective vacuum target pressure gradient for each of the control circuit devices.

4. The apparatus according to claim 1, wherein the control circuit devices each comprise at least one triggerable valve unit and/or a vacuum pump.

5. The apparatus according to claim 1, wherein the control circuit devices each comprise at least one pressure sensor for detecting an actual vacuum pressure gradient as a controlled variable.

6. The apparatus according to claim 1, further comprising a central power supply for the control circuit devices.

7. The apparatus according to claim 1, wherein the vacuum cooling station comprises at least one drive device for linearly and/or non-linearly moving the vacuum cooling chambers along a cooling section.

8. The apparatus according to claim 7, wherein the at least one drive device comprises opposing drive units for moving respective chamber halves of the vacuum cooling chambers.

9. The apparatus according to claim 1, wherein each of the vacuum cooling chambers in a closed state has a chamber wall that is formed by a product conveyor.

10. The apparatus according to claim 1, wherein the vacuum cooling chambers are lockable along the cooling path.

11. The apparatus according to claim 1, wherein the apparatus comprises a conveyor for continuously supplying products to the vacuum cooling station.

12. A packaging system having a baking device, the apparatus according to claim 1, and a tubular bag machine.

13. A method for vacuum cooling products, the method comprising:
receiving at least one product in each of multiple continuously moved vacuum cooling chambers, wherein each vacuum cooling chamber has its own control circuit device; and
operating each vacuum cooling chamber, while it is moved along a cooling path together with the at least one product received therein, by its own control circuit device designed for dynamic vacuum pressure generation.

14. The method according to claim 13, wherein the control circuit devices each wirelessly receive a vacuum target pressure gradient as a command variable for dynamically generating the vacuum pressure.

15. The method according to claim 13, wherein the vacuum target pressure gradients are formed as a function of a temperature of the products to be cooled.
